(19) United States
(12) Patent Application Publication
(10) Pub. No.: US 2013/0119717 A1
(43) Pub. Date: May 16, 2013

(54) THERMOELECTRIC MODULE AND TEMPERATURE CONTROLLED VEHICLE SEAT COMPRISING THE SAME

(71) Applicants: Qing Gong, Shenzhen (CN); Qingchun Yang, Shenzhen (CN); Dajun Chen, Shenzhen (CN)

(72) Inventors: Qing Gong, Shenzhen (CN); Qingchun Yang, Shenzhen (CN); Dajun Chen, Shenzhen (CN)

(73) Assignees: BYD COMPANY LIMITED, Shenzhen (CN); SHENZHEN BYD AUTO R&D COMPANY LIMITED, Shenzhen (CN)

(21) Appl. No.: 13/812,428

(22) PCT Filed: Jul. 19, 2011
(86) PCT No.: PCT/CN2011/077337

§ 371 Date: Jan. 25, 2013

(30) Foreign Application Priority Data
Jul. 28, 2010 (CN) 201020281744.2

(51) Int. Cl. F25B 21/04; B60N 2/56

(52) U.S. Cl. CPC F25B 21/04; B60N 2/56
USPC 297/180.12; 62/3.3

(57) ABSTRACT

A thermoelectric module including at least two heat exchanging units connected in series is provided. Each heating exchanging unit includes: a main body having an inlet for intaking cooling medium; a thermoelectric element provided in the main body which divides the main body into a working chamber formed with a working medium outlet and a waste heat chamber formed with a waste medium outlet. The working medium outlet of one of two neighboring heat exchanging units is connected with the inlet of the remaining of the two neighboring heat exchanging units. A temperature controlled vehicle seat comprising the thermoelectric module is also provided.

### CROSS-REFERENCE TO RELATED APPLICATION

This application claims priority to, and benefits of Chinese Patent Application No. 201020281744.2 filed with State Intellectual Property Office, P. R. C. on Jul. 28, 2010, the entire content of which is incorporated herein by reference.

### FIELD

The present disclosure relates to vehicles, more particularly to a thermoelectric module for a temperature controlled vehicle seat and a temperature controlled vehicle seat comprising the same.

### BACKGROUND

With the rapid development of automobiles, there are more and more requirements for indoor comfortableness of the automobiles. In conventional automobiles, air-conditioners are always applied to adjust indoor temperatures of the automobiles and make passengers feel more comfortable. In some middle and high grade automobiles, thermoelectric modules may be used to heat or cool the automobile seat to a predetermined temperature.

### SUMMARY

The present disclosure is directed to solve at least one of the problems existing in the art. Accordingly, a thermoelectric module may need to be provided, via which an enlarged temperature variable range may be achieved easily. Further, a temperature controlled vehicle seat comprising the same may also need to be provided, which may enlarge temperature control range, thus enhancing comfortableness of a passenger sitting on the seat.

According to an aspect of the present disclosure, a thermoelectric module comprising at least two heat exchanging units connected in series may be provided. Each heat exchanging unit may comprise a main body having an inlet for intaking heating or cooling medium; a thermoelectric element provided in the main body which divides the main body into a working chamber formed with a working medium outlet and a waste heat chamber formed with a waste medium outlet. The working medium outlet of one of two neighboring heat exchanging units is connected with the inlet of a remaining of the two neighboring heat exchanging units.

According to another aspect of the present disclosure, a temperature controlled vehicle seat may be provided. The vehicle seat may comprise: a seat body; a medium passage formed inside the seat body; a thermoelectric module as described hereinabove with the inlet of the heat exchanging unit being connected with the medium passage; and a medium source for supplying cooling or heating medium to the inlet of the thermoelectric module.

According to embodiments of the present disclosure, the thermoelectric module comprises at least two heat exchanging units, and latter heat exchanging unit of two adjacent heat exchanging units may provide another stage temperature change besides that provided by the former heat exchanging unit. In this way, the temperature in the working chambers may be increased or decreased step by step to achieve further heating/cooling, thus achieve an enlarged temperature variable range. When this thermoelectric module is applied to a vehicle seat, comfortableness of a passenger sitting on the seat is enhanced due to the enlarged temperature variable range.

### BRIEF DESCRIPTION OF THE DRAWINGS

These and other aspects and advantages of the disclosure will become apparent and more readily appreciated from the following descriptions taken in conjunction with the drawings in which:

FIG. 1 is a schematic view of a thermoelectric module according to an embodiment of the present disclosure;

FIG. 2 is a perspective view of a thermoelectric element in a heat exchanging unit in FIG. 1;

FIG. 3 is a cross sectional view of the thermoelectric element in a first heat exchanging unit along line A-A′ in FIG. 1;

FIG. 4 is a cross sectional view of a thermoelectric element in a second heat exchanging unit along line B-B′ in FIG. 1;

FIG. 5 is a cross sectional view of a thermoelectric element in a third heat exchanging unit along line C-C′ in FIG. 1; and

FIG. 6 is a schematic view of a temperature controlled vehicle seat according to an embodiment of the present disclosure with an enlarged part D being shown on the left side.

### DETAILED DESCRIPTION

Reference will be made in detail to embodiments of the present disclosure. The embodiments described herein are explanatory, illustrative, and used to generally understand the present disclosure. The embodiments shall not be construed to limit the present disclosure. The same or similar elements and the elements having same or similar functions are denoted by like reference numerals throughout the descriptions.

In the following, a thermoelectric module and a temperature controlled vehicle seat comprising the same will be described in detail with reference to accompanying figures, in which FIG. 1 is a schematic view of the thermoelectric module 100 according to an embodiment of the present disclosure.

The thermoelectric module 100 may comprise at least two heat exchanging units connected in series. As shown in FIG. 1, there are three heat exchanging units 1, 2 and 3 connected in series. However, it should be noted that the three heat exchanging units, i.e., the first heat exchanging unit 1, the second heat exchanging unit 2, and the third heat exchanging unit 3, are shown for illustrative purpose rather than limitation. For convenience purpose, in the following, cooling medium is used for depicting the principles of the present disclosure. However, it is obvious for an artisan skilled in the art to use heating medium such as air or water, for heating purpose. Therefore, the scope of the claims as attached should also cover this alternative. In the following, each heat exchanging unit will be described in detail. As shown in FIG. 1, the first heat exchanging unit 1 may comprise a first main body 10 having an inlet 14 for intaking cooling medium 50 indicated by arrows shown in FIG. 1; a thermoelectric element 11 provided in the main body 10 which divides the main body 10 into a working chamber 12 formed with an working medium outlet 124 and a waste heat chamber 13 formed with a waste medium outlet 134. Also, the second heat exchanging unit 2 may comprise a second main body 20 having an inlet 24 for intaking cooling medium 50 indicated by arrows shown in FIG. 1; a thermoelectric element 21 provided in the main body 20 which divides the main body 20 into a working chamber 22 formed with an working medium outlet 224 and a waste heat chamber 23 formed with a waste medium outlet 234. And the third heat exchanging unit 3 may comprise a third main body 30 having an inlet 34 for intaking cooling medium 50 indicated by arrows shown in FIG. 1; a thermoelectric element 31 provided in the main body 30 which divides the main body 30 into a working chamber 33 formed with an working medium outlet 324 and a waste heat chamber 33 formed with a waste medium outlet 334.

The first, second and third thermoelectric element 11, 21 and 31 are horizontally connected to a side of the main body 10, 20 and 30 opposite to the inlet 14, 24 and 34 respectively.

As shown in FIG. 1, the inlet 24 of the second heat exchanging unit 2 is in fluid communication with the working medium outlet 124, and the inlet 34 is in fluid communication with the working medium outlet 224. That is to say, the working medium outlet of one of two neighboring heat exchanging units is connected with the inlet of a remaining of the two neighboring heat exchanging units.

As shown in FIG. 6, the inlet 14 of the first heat exchanging unit 1 may be connected with a cooling medium source 50 such as a fan or water source etc, and the cooling medium may be discharged from the working medium outlet 324 of the third heat exchanging unit 3 with a desired temperature.

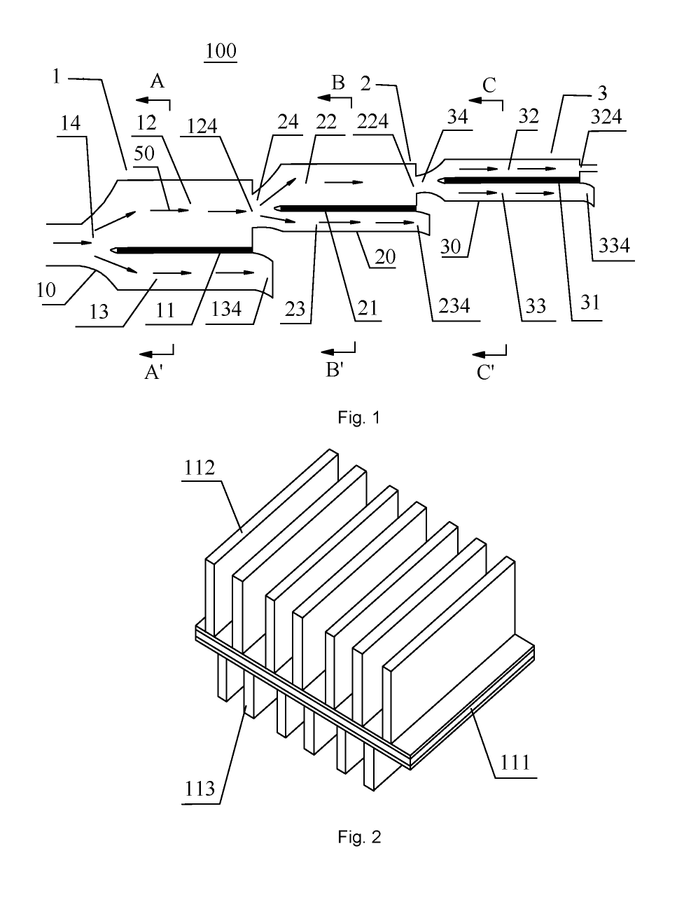

In the following, the thermoelectric element will be described with reference to FIGS. 2-5, in which FIG. 2 is a perspective view of the thermoelectric element 11 in the heat exchanging unit 1 in FIG. 1.

As shown in FIG. 2, the thermoelectric element 11 comprises a first semiconductor member 111, a first upper radiating member 112, and a first lower radiating member 113. The first upper radiating member 112 is provided on an upper surface of the semiconductor member projecting into the working chamber 12. And the lower radiating member 113 is provided on a lower surface of the semiconductor member 111 projecting into the waste heat chamber 13. Similarly, the thermoelectric element 21 comprises a second semiconductor member 211, a second upper radiating member 212, and a second lower radiating member 213. The second upper radiating member 212 is provided on an upper surface of the semiconductor member projecting into the working chamber 22. And the second lower radiating member 213 is provided on a lower surface of the semiconductor member 211 projecting into the waste heat chamber 23. The thermoelectric element 31 comprises a third semiconductor member 311, a third upper radiating member 312, and a third lower radiating member 313. The third upper radiating member 312 is provided on an upper surface of the semiconductor member projecting into the working chamber 32. And the third lower radiating member 313 is provided on a lower surface of the semiconductor member 311 projecting into the waste heat chamber 33. It should be noted that the semiconductor member mentioned above may be a semiconducting thermoelectric module based on Peltire Effect. For example, thermocouples may be directly adopted. For further enhancing heating/cooling effect, the semiconductor member may be thermoelectronics formed by connecting thermocouples in series or in parallel.

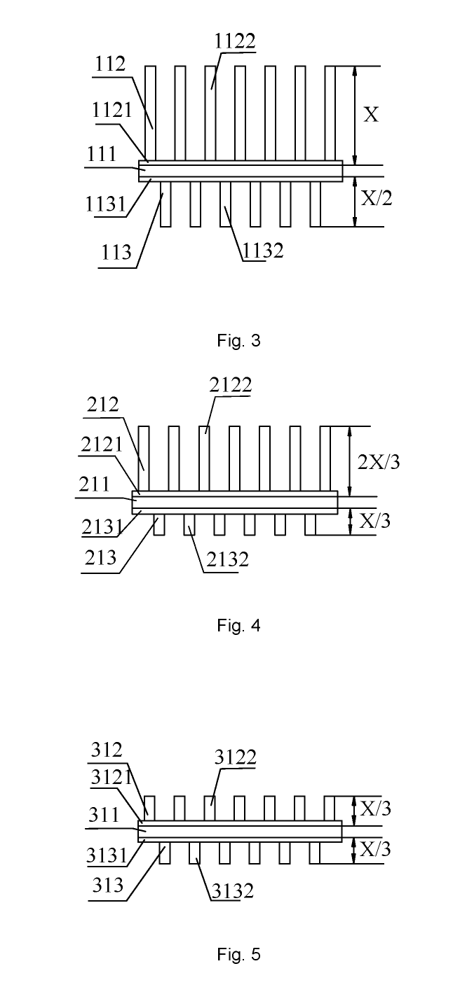

As shown in FIG. 3, the first upper radiating member 112 comprises: a radiating base 1121; and a plurality of radiating fins 1122 parallel to each other formed on the radiating base 1121 respectively, with the radiating base 1121 of the first upper radiating member 112 in contact with the upper surface of the semiconductor member 111. The first lower radiating member 113 comprises: a radiating base 1131; and a plurality of radiating fins 1132 parallel to each other formed on the radiating base 1131 respectively, with the radiating base 1131 of the first lower radiating member 113 in contact with the lower surface of the semiconductor member 111.

As shown in FIG. 4, the second upper radiating member 212 comprises: a radiating base 2121; and a plurality of radiating fins 2122 parallel to each other formed on the radiating base 2121 respectively, with the radiating base 2121 of the second upper radiating member 212 in contact with the upper surface of the semiconductor member 211. The second lower radiating member 213 comprises: a radiating base 2131; and a plurality of radiating fins 2132 parallel to each other formed on the radiating base 2131 respectively, with the radiating base 2131 of the second lower radiating member 213 in contact with the lower surface of the semiconductor member 211.

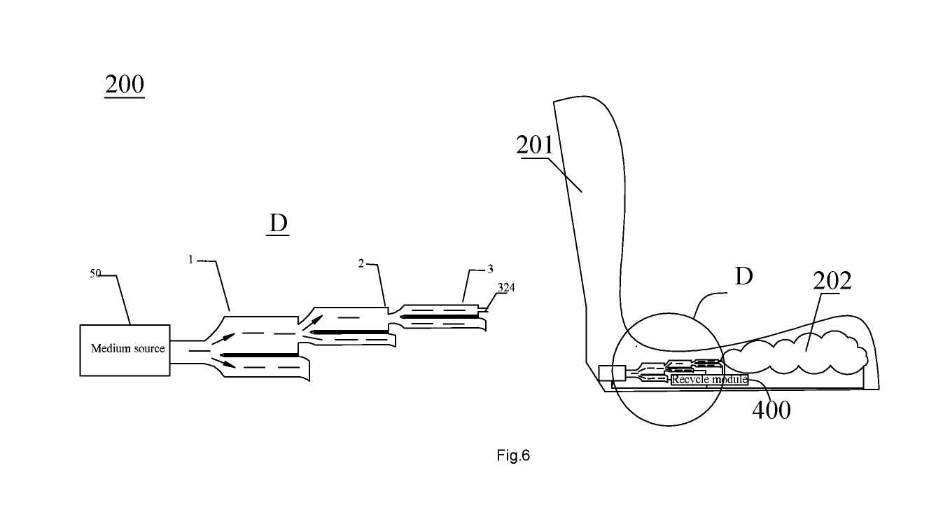

As shown in FIG. 5, the third upper radiating member 312 comprises: a radiating base 3121; and a plurality of radiating fins 3122 parallel to each other formed on the radiating base 3121 respectively, with the radiating base 3121 of the third upper radiating member 312 in contact with the upper surface of the semiconductor member 311. The third lower radiating member 313 comprises: a radiating base 3131; and a plurality of radiating fins 3132 parallel to each other formed on the radiating base 3131 respectively, with the radiating base 3131 of the third lower radiating member 313 in contact with the lower surface of the semiconductor member 311.

In the following, the configuration of the upper and lower radiating members will be described in detail as follows.

According to embodiments of the present disclosure, the thermoelectric module 100 may provide more efficient heat transferring capability, provided that heights of the radiating members of the thermoelectric element satisfy a certain ratio. After numerous experimentations, the inventor has found that the following dimensions of the heat exchanging units 1, 2 and 3 may provide the most efficient heat transferring capability.

As shown in FIG. 3, the first upper radiating member 112 has a height of X, and the first lower radiating member 113 has a height of X/2.

As shown in FIG. 4, the second upper radiating member 212 has a height of 2X/3, and the second lower radiating member 213 has a height of X/3.

Normally, the last heat exchanging unit in the at least two heat exchanging units connected in series may have the upper radiating member with a height equal to that of the lower radiating member. For example, as shown in FIG. 5, both the third upper radiating member 312 and the third lower radiating member 313 have a height of X/3.

Each of the heat exchanging unit except the last heat exchanging unit has the lower radiating member with a height which is half that of the upper radiating member. As shown in FIGS. 3 and 4, the first upper radiating member 112 has a height of X, and the first lower radiating member 113 has a height of X/2. The second upper radiating member 212 has a height of 2X/3, and the second lower radiating member 213 has a height of X/3. It should be noted that the height as mentioned here means the total heights of the radiating base and the radiating fins in a vertical direction shown in FIGS. 3-5.

When there are more than three heat exchanging units in the thermoelectric module 100, the upper radiating member 312 in the last heat exchanging unit 3 has a height half of that of the upper radiating member 212 in the last but one heat exchanging unit 2, i.e., the heat exchanging unit 2 in this embodiment. For example, as shown in FIGS. 4 and 5, the third upper radiating member 312 has a height half of that of the second upper radiating member 212.

Except the last heat exchanging unit 3, the latter of the two neighboring heat exchanging units has the upper radiating member with a height which is about two thirds of that of the upper radiating member in the former one of the two neighboring heat exchanging units. For example, as shown in FIGS. 3 and 4, the second upper radiating member 212 has a height two thirds of that of the first upper radiating member 112.

According to an embodiment of the present disclosure, the thermoelectric module may further comprise a control unit (not shown) connected with the semiconductor member for controlling current magnitude and direction to cool or heat the medium in the main body. To be specific, the control unit may be used to adjust the magnitude and direction of a current in the semiconductor member. The control unit may control heating or cooling conditions within the working chamber of the heat exchanging unit through controlling the heating or cooling of an upper surface of the semiconductor member. In this way, heating or cooling function of the thermoelectric module 100 may be achieved.

It should be understood that the cooling medium 100 described herein may be any known medium in the art that can provide a cooling capability.

In an embodiment, the thermoelectric module 100 may comprise at least two heat exchanging units. When the medium, such as the cooling medium flows through the thermoelectric module 100, i.e. from the front one of two adjacent heat exchanging units and exits from the working medium outlet and the waste medium outlet respectively, a temperature change may occur to the cooling medium. Inlet of the latter heat exchanging unit of the two neighboring heat exchanging units may be formed to be connected with the working medium outlet of the former heat exchanging unit of the two neighboring heat exchanging units. After the cooling medium exits from the working medium outlet of the two neighboring heat exchanging units, an additional temperature change may occur, thus making the cooling medium have a higher or lower temperature. In this way, further cooling or heating of the cooling medium can be achieved.

According to embodiments of the present disclosure, the thermoelectric module 100 may be used in any known temperature adjusting or temperature controlling fields, such as heat dissipating fields of electronic components, for example temperature controlled vehicle seats.

In the following, a temperature controlled vehicle seat 200 may be described in detail with reference to FIG. 6.

As shown in FIG. 6, the temperature controlled vehicle seat 200 may comprise: a seat body 201; a medium passage 202 formed inside the seat body 201; a thermoelectric module 100 as described hereinabove with the working medium outlet 324 of the last heat exchanging unit 3 herein being connected with the medium passage 202; and a medium source 50 for supplying cooling or heating medium to the inlet 14 of the first heat exchanging unit 1 in thermoelectric module 100. As shown in FIG. 6, the medium in the waste heat chamber 13, 23 and 33 may be discharged outside the seat body 201 via the waste heat outlet 134, 234, 334 of each heat exchanging unit 1, 2 and 3.

In an embodiment, the medium source 50 may be a fan or a water pump with the cooling medium being air or water etc. As shown in FIG. 6, both the medium source 50 and the thermoelectric module 100 may be disposed within the seat body 201.

When the thermoelectric module 100 as described in FIG. 1 is applied in the temperature controlled vehicle seat 200, the first heat exchanging unit 1 is formed with its inlet 14 connected with the medium source 50, such as a cooling medium source, and the working medium outlet 324 in the heat exchanging unit 3 may be connected with the medium passage 202 in the seat body 201. Therefore, cooling medium flows through and circulate within the seat body 201 to increase or decrease temperature of the seat surface. Correspondingly, all waste medium outlets of the thermoelectric module, such as the first, second, and third waste medium outlets 134, 234, 334 as shown in FIG. 1, are connected to the outside of the seat body 201, to avoid probably negative influences on the working efficiency of the thermoelectric module 100. In an embodiment, the cooling medium may be water. Water discharged from the waste heat chamber may be collected in a recycled device (not shown) provided outside of the vehicle seat 200. The water in the recycled device can be recycled and applied as cooling medium more than one time.

In the following, a pump (not shown) as a cooling medium source is adopted, and water with a temperature of 25° C. is used as the cooling medium, and each thermoelectric element comprises only one semiconductor member and semiconductor members in all thermoelectric elements may have the same power.

In the following, the working process will be described with reference to FIG. 1.

The water from the pump flows through its own outlet, to the inlet 14 of the first heat exchanging unit 1. Then the water is divided into two branches with one branch flowing into the working chamber 12 and the waste heat chamber 13. The water arriving at the working chamber 12 passes through passages formed between the first upper radiating fins 1122, and flows out of the heat exchanging unit 1 via the working medium outlet 124 with a temperature of 20° C. The water arriving at the waste heat chamber 13 passes through passages formed between the lower radiating members 113, and flows out of the heat exchanging unit 1 via the waste medium outlet 134 to the outside of the seat body 201 with a temperature of 30° C.

The water from the working medium outlet 124 with a temperature of 20° C. flows through the inlet 24 of the second heat exchanging unit 2, and is divided into two branches. Then, the water flows to the working chamber 22 and the waste heat chamber 23 respectively. The water arriving at the working chamber 22 passes through passages formed between the second upper radiating fins 2122, and flows out of the second heat exchanging unit 2 via the working medium outlet 224 with a temperature of 15° C. The water arriving at the second waste heat chamber 23 passes through passages formed between the lower radiating fins 2132, and flows out of the second heat exchanging unit 2 via the waste medium outlet 234 to the outside of the seat body 201 with a temperature of 25° C.

The water from the second working medium outlet 224 with a temperature of 15° C. goes through the inlet 34 of the third heat exchanging unit 3, and is divided into two branches. Then the water flows to the working chamber 32 and the waste heat chamber 33 respectively. The water arriving at the working chamber 32 passes through passages formed between the third upper radiating fins 3122, and flows out of the third heat exchanging unit 3 via the working medium outlet 324 with a temperature of 10° C. The water with a temperature of 10° C. flows into the medium passage 202 formed in the seat body 201 to adjust the surface temperature of the seat body 201, thus enhancing comfortableness of the passenger(s) sitting on the seat. The water arriving at the third waste heat chamber 33 passes through passages formed between the third lower radiating fins 3132, and flows out of the third heat exchanging unit 3 via the waste medium outlet 334 to the outside of the seat body 201 with a temperature of 20° C.

The water flowing in the medium passage 202 of the seat body 201 may further be connected to or communicated with the inlet 14 of the first heat exchanging unit 1, so that the cooling medium may be recycled accordingly. As shown in FIG. 6, the vehicle seat 200 further comprises a recycle module 400, which is connected with the waste medium outlets 134, 234, 334 of the heat exchange units 1, 2, 3 respectively for collecting the discharged cooling medium and supplying thereof to the medium source 50.

Although explanatory embodiments have been shown and described, it would be appreciated by those skilled in the art that changes, alternatives, and modifications all falling into the scope of the claims and their equivalents may be made in the embodiments without departing from spirit and principles of the present disclosure.

1. A thermoelectric module comprising at least two heat exchanging units connected in series, each heat exchanging unit comprising:
a main body having an inlet for intaking a heating or cooling medium;
a thermoelectric element provided in the main body which divides the main body into a working chamber formed with a working medium outlet and a waste heat chamber formed with a waste medium outlet, wherein
the working medium outlet of one of two neighboring heat exchanging units is connected with the inlet of a remaining of the two neighboring heat exchanging units.

2. The thermoelectric module according to claim 1, wherein the thermoelectric element is horizontally connected to a side of the main body opposite to the inlet.

3. The thermoelectric module according to claim 1, wherein the thermoelectric element comprises:
at least a semiconductor member;
an upper radiating member provided on an upper surface of the semiconductor member projecting into the working chamber; and
a lower radiating member provided on a lower surface of the semiconductor member projecting into the waste heat chamber.

4. The thermoelectric module according to claim 3, wherein the semiconductor member is a semiconducting thermoelectric module based on Peltier Effect.

5. The thermoelectric module according to claim 3, wherein each of the upper and the lower radiating members comprises: a radiating base; and a plurality of radiating fins parallel to each other and formed on the radiating base respectively, with the radiating base of the upper radiating member in contact with the upper surface of the semiconductor member and the radiating base of the lower radiating member in contact with the lower surface of the semiconductor member.

6. The thermoelectric module according to claim 5, wherein a last heat exchanging unit in the at least two heat exchanging units connected in series has the upper radiating member with a height equal to that of the lower radiating member.

7. The thermoelectric module according to claim 5, wherein each of the heat exchanging unit except a last heat exchanging unit in the at least two heat exchanging units connected in series has the lower radiating member with a height which is half that of the upper radiating member.

8. The thermoelectric module according to claim 7, wherein there are more than three heat exchanging units in the thermoelectric module, and the upper radiating member in the last heat exchanging unit has a height half of that of the upper radiating member in the last but one heat exchanging unit.

9. The thermoelectric module according to claim 8, wherein except the last heat exchanging unit, the latter of the two neighboring heat exchanging units has the upper radiating member with a height which is about two thirds of that of the upper radiating member in the former one of the two neighboring heat exchanging units.

10. The thermoelectric module according to claim 3, further comprising:
a control unit connected with the semiconductor member and configured to control current magnitude and direction to cool or heat the medium in the main body.

11. A temperature controlled vehicle seat, comprising:
a seat body;
a medium passage formed inside the seat body;
a thermoelectric module comprising at least two heat exchanging units connected in series, each heat exchanging unit comprising:
a main body having an inlet for intaking a heating or cooling medium;
a thermoelectric element provided in the main body which divides the main body into a working chamber formed with a working medium outlet and a waste heat chamber formed with a waste medium outlet, wherein
the working medium outlet of one of two neighboring heat exchanging units is connected with the inlet of a remaining of the two neighboring heat exchanging units, and
with the working medium outlet of a last heat exchanging unit therein being connected with the medium passage; and
a medium source for supplying cooling or heating medium to the inlet of the thermoelectric module.

12. The vehicle seat according to claim 10, wherein the medium in the waste heat chamber is discharged outside the seat body via the waste heat outlet of each heat exchanging unit.

13. The vehicle seat according to claim 12, wherein the medium source comprises a fan or a pump for supplying heating or cooling gas or water into the thermoelectric module.

14. The vehicle seat according to claim 13, wherein both the medium source and the thermoelectric module are disposed within the seat body.

15. The vehicle seat according to claim 14, further comprising:
a recycle module connected with the waste medium outlets of the heat exchange units respectively for collecting the discharged heating or cooling medium and supplying the medium to the medium source.
